(19) United States
(12) Patent Application Publication
(10) Pub. No.: US 2026/0062982 A1
(43) Pub. Date: Mar. 5, 2026

(54) OVERHEAD DOOR

(71) Applicant: Ridge Corporation, Pataskala, OH (US)

(72) Inventors: Gary Alan Grandominico, Galena, OH (US); Raymond Augustus McDonald, JR., Pooler, GA (US); Bret Jameson Moss, Lewis Center, OH (US)

(21) Appl. No.: 19/314,632

(22) Filed: Aug. 29, 2025

Related U.S. Application Data
(60) Provisional application No. 63/689,060, filed on Aug. 30, 2024.

(51) Int. Cl. E06B 3/48

(52) U.S. Cl. CPC E06B 3/486; E06B 3/487

(57) ABSTRACT

A panel door for traversing a curved track. The panel door includes front and back faces formed by membranes and a central area between the membranes with a core material. The back face has a plurality of openings having a set width. The openings in the back face align with channels in the central area. The channels have a width that varies along the depth or the depth of the channel extends to the opposite membrane such that a portion of the membrane is exposed by the channel.

This application claims priority to and any other benefit of U.S. Provisional Patent Application Ser. No. 63/689,060 filed Aug. 30, 2024, the contents of which are incorporated herein in their entirety by reference.

### TECHNICAL FIELD

The present disclosure relates generally to the field of overhead doors and, in particular, panel roll doors designed to roll from a closed position to an open position.

### BACKGROUND

Overhead doors are designed to roll up on a set of tracks that often include a curved section that requires the door to bend to traverse from an open position to a closed position. Multi-section doors are conventionally used to accommodate door bend at the section of curved track. The multi-section doors are undesirably heavy and show exposed seam lines, and sometimes hardware, at each section hinge on the outermost surfaces of the door. The present invention aims to reduce the weight of overhead doors while providing a flexible panel design that have protected front and/or back faces for withstanding exposure to the operating environments.

### SUMMARY

The following is a brief summary of subject matter that is described in greater detail herein. This summary is not intended to be limiting as to the scope of the claims.

In an embodiment, a panel door for rolling along a curved track includes the door having a perimeter that includes a top surface, a bottom surface, a first side surface and a second side surface. The panel door further includes a back face formed by a first membrane, a front face formed by a second membrane, a central area including a core material positioned between the first membrane and the second membrane, an opening formed in the back face through the first membrane such that the opening has a length extending from the first side surface to the second side surface and a width (W) perpendicular to the length of the opening, a channel in the central area such that the channel is open to the opening in the back face and the channel has a length extending from the first side surface to the second side surface, a width (W1) perpendicular to the length of the channel, and a depth (D) extending from the opening in the back face inward towards the front face. The panel door has a design that includes the width (W1) of the channel in the central area being varied or not a consistent width along its depth (D) as it extends from the back face membrane opening towards the front face and/or the design of the panel door includes the depth (D) of the channel being such that the depth (D) extends to the second membrane in the front face, wherein a portion of the second membrane is exposed by the channel. In the cross-section of the channel where a portion of the second membrane is exposed, the channel is devoid of any core material and forms an open area in the central area of the panel door residing between the first and second membranes.

In an example embodiment, the central area is occupied with a continuous core material that contains the channel or a plurality of channels, the continuous core material directly contacting the first membrane and the second membrane.

In another embodiment, the first membrane of the back face and the second membrane of the front face are formed of a fiber reinforced thermoplastic material, and the core material is a foam material adhered to the first membrane of the back face and the second membrane of the front face.

In another embodiment, the width (W) of the opening or openings in the back face of the panel door are each connected with an individual channel in the central area. The opening widths (W) in the back face of the panel door are equal to or less than the average width (W1) of the channel connected with the opening. The average width (W1) of the channels are taken along the depth (D) of the channel. In some embodiments, 50 to 90% of the depth of the channel has a width that is greater than the width of the opening in the back face that the channel is connected. In other embodiments, the ratio of the average width (W1) of the channel to the width (W) of the opening formed in the back face that it is connected with is in the range of 1.2:1 to 3:1.

In another embodiment, the channel in the central area of the panel door extends entirely through the core material and to a first surface formed by the second membrane of the front face. The channel thereby forms a cavity that exposes a portion of the second membrane as accessed through the opening in the back face. In some embodiments, the channel further extends into the second membrane such that the second membrane has an area of reduced thickness. The area of reduced thickness in the second membrane improve flexibility of the font face and second membrane at the location of the channel in the central area.

In another embodiment, the panel door has a channel with an inlet in communication or connected with the opening in the back face, a first channel side surface, a second channel side surface, and a bottom channel surface. The first and second channel side surfaces are positioned below the back face and/or first membrane and generally extend from the back face to the front face and in some instances the side surfaces extend entirely from the back face to the front face. The bottom channel surface connects the first and second channel side surfaces. In some embodiments, the first channel side surface is not parallel with the second channel side surface along the depth (D) of the channel. For instance, the first and second channel side surfaces converge away from one another or towards one another (e.g., in a non-square or non-rectangular shape). In some embodiments, the first channel side surface is parallel with the second channel side surface along the depth (D) of the channel. For instance, the channel is in the shape of a rectangle with one side of the rectangle defined by the opening in the back face and the opposite side of the rectangle being the bottom channel surface, with the first and second channel side surfaces connecting the two sides. In some embodiments, the bottom channel surface has a width (W2) that is greater than the width (W) of the opening formed in the back face that the channel is connected. For example, the ratio of the width (W2) of the bottom channel surface to the width (W) of the opening formed in the back face is in the range of 1.2:1 to 3:1. In some embodiments, a portion of the core material is positioned below the bottom channel surface. In this instance, the walls of the channel that are the bottom surface and first and second side surfaces can be made of core material. In some other embodiments, the first channel surface, the second channel surface or the bottom channel surface has a cover layer overlying a portion of the core material of the central area to prevent the walls of the channel being formed of exposed core material (e.g., foam).

In another embodiment, the panel door can have a channel that includes an exposed surface accessible through the opening in the back face, the exposed surface of the channel includes a cover layer and the cover layer overlies a portion of the core material of the central area or a portion of the second membrane of the front face. The cover layer can be a polymeric layer and be directly adhered to the core material and/or second membrane. The cover layer is flexible to accommodate bending and flexing of the panel door at or near the channels. In some embodiments, the channel houses an insert, the insert has an outer surface and a portion of the outer surface of the insert forms a portion of the back face, the portion of the outer surface of the insert resides in the opening in the back face such that the opening is filled with the insert. The insert can be made of a polymeric material. The insert is flexible to accommodate bending and flexing of the panel door at or near the channels. As arranged in the channel, the outer surface of the insert contacts a first channel side surface and a second channel side surface of the channel in the central area.

In some embodiments, the panel door may include a plurality of channels in the central area, the plurality of channels being spaced apart from one another between the top surface and the bottom surface of the panel door. In some embodiments, the central area can include two or more sections of core material, the two sections of core material being spaced apart from one another to form a first channel side surface and a second channel side surface of the channel in the central area. In some embodiments, the panel door has a plurality of spaced apart channels in the central area, a plurality of openings formed in the back face through the first membrane, each opening of the plurality of openings having a length extending from the first side surface to the second side surface, each opening of the plurality of openings having a width (W) perpendicular to the length of the openings, each channel of the plurality of channels being open to an opening in the plurality of openings, each channel in the plurality of channels having a length extending from the first side surface to the second side surface, a width (W1) perpendicular to the length of the channel and a depth (D) extending from the opening in the back face inward towards the front face, wherein the width (W1) of each of the channels varies along its depth (D) and/or the depth (D) of each of the channels extends to the second membrane such that a portion of the second membrane is exposed by each of the channels, wherein the plurality of channels provides flexible sections to the single panel door for traversing a curved portion in the track.

In yet another embodiment, the front face of the panel door is a continuous planar surface. The planar surface may be formed by the second membrane, which may be a thermoplastic material having a smooth surface.

In yet another embodiment, the panel door is a single panel door.

In yet another embodiment, the panel door has intermediate sections positioned between a plurality of channels and connected openings in the back face such that the intermediate sections are substantially rigid and the plurality of channels and connected openings in the back face form flexible sections of the panel door for traversing a curved portion of a track.

In another embodiment, the one or more openings in the back face of the panel door are covered with a patch or flexible seal to close the channel and prevent exposure to surfaces in the channel. The patch or seal is flexible and allows the door to flex and bend at the opening and channel. The patch or seal is adhered to the back face of the door to provide a continuous surface on the back face.

In some embodiments, the channel of the panel door, extending from the first side surface to the second side surface, has an area less than an area of any of the top surface, the bottom surface, the first side surface and the second side surface of the perimeter of the panel door. In other embodiments, the panel door has a plurality of channels, each extending from the first side surface to the second side surface, and each has an area less than an area of any of the top surface, the bottom surface, the first side surface and the second side surface of the perimeter of the panel door.

In some embodiments, the panel door can be devoid of openings on its back face and the central area between the first and second membranes can include one or more gaps or a plurality of spaced apart gaps that extend from the first side surface to the second side surface. In other embodiments, the one or more gaps, or plurality of spaced apart gaps, can alternatively extend from the top surface to the bottom surface of the panel door. The gaps in the central area between the first and second membranes can have any suitable shape, for example, a non-rectangular shape.

In some embodiments, the panel door can be devoid of openings on its back face and the central area between the first and second membranes can include one or more cavities extending along its entire width, length or thickness. In an example, the one or more cavities extend inside core material from the first side surface to the second side surface and do not intersect one or more of the top surface, the front face, the back face, or the bottom surface of the panel door. In another example, the one or more cavities extend inside core material from the top surface to the bottom surface, and the one or more cavities do not intersect one or more of the first side surface, the front face, the back face, or the second side surface. In yet another example, the one or more cavities extend along the entire thickness of the core from the front face to the back face, and the one or more cavities do not intersect one or more of the top surface, the first side surface, the second side surface, or the bottom surface.

The above summary presents a simplified summary in order to provide a basic understanding of some aspects of the compositions, items of manufacture, and/or methods discussed herein. This summary is not an extensive overview of the subject matter discussed herein. Its sole purpose is to present some concepts in a simplified form as a prelude to the more detailed description that is presented later.

### BRIEF DESCRIPTION OF THE DRAWINGS

The present disclosure is better understood when the following detailed description is read with reference to the accompanying drawings.

The drawings constitute a part of this specification and include exemplary embodiments of the invention, which may also be embodied in various forms. It is further understood that in instances the aspects or embodiments of the invention may be shown exaggerated or enlarged to facilitate a particular understanding of the invention.

FIG. 1 shows a perspective view of a panel door positioned in a set of tracks having a curved portion. The panel door has a smooth, continuous front face surface, a channeled back face surface and a perimeter. Example wheels are shown for movement of the door in guide tracks.

FIG. 2 shows a perspective view of a portion of the panel door of FIG. 1 taken along section line A. The openings in the back face of the door and the channels in the central area are shown and extend length wise, with a uniform cross-section, from a first side surface to a second side surface of the door.

FIG. 3 shows another perspective view of a portion of the panel door of FIG. 1 taken along section line A.

FIG. 4 shows a perspective view of an example of the panel door being flexed at portions with openings in the back face and channels in the central area. The panel door has hardware for connecting wheels to the door. The hardware is secured to the back face of the door along the sides.

FIG. 5 shows an example side cross-section view of a single panel door having an opening extending through a first membrane and a channel in the core material underlying the first membrane. The width of the opening in the first membrane is equal to, and preferably smaller, than the width of the remaining channel area positioned in the core and underlying the first membrane.

FIG. 6 shows an example side cross-section view of a panel door having an opening extending through a first membrane and a channel open to a surface of a second membrane and entirely through a core positioned between the first and second membranes. The width of the opening in the first membrane is equal to, and preferably smaller, than the width of the remaining section of the channel in the core and on the surface of the second membrane.

FIG. 7 shows an example side cross-section view of a panel door having an opening extending through a first membrane and a channel extending into a portion of a second membrane through a core positioned between the first and second membranes. The cutout portion of the second membrane forms a portion of the second membrane having a reduced thickness for increasing flexibility of the panel door at the channel areas.

FIG. 8 shows an example side cross-section view of a panel door having an opening extending through a first membrane and a channel in the core underlying the first membrane. The exposed surface of the walls of the channel is covered with a cover layer or coating such that the edges of the first membrane in the opening and core surface in the channel are not directly exposed to the environment thereby adding a protective barrier to the exposed, non-exterior facing areas of the door.

FIG. 9 shows an example side cross-section view of a panel door an opening extending through a first membrane and a channel extending to a surface of a second membrane and entirely through a core positioned between the first and second membranes. The exposed surface of the channel and opening is covered with a cover layer or coating such that the edges of the first membrane, surface of the second membrane and core is not directly exposed to the environment thereby adding a protective barrier to the exposed, non-exterior facing areas of the door.

FIG. 10 shows an example side cross-section view of a panel door having an opening extending through a first membrane and a channel extending into a portion of the core underlying the first membrane. An insert is positioned in the opening in the back face to fill the opening and form a continuous planar surface with the first membrane. A plurality of channels in a panel door can be similarly filled with inserts to form a back face of the door that is a continuous surface. The insert or inserts prevent environmental exposure to the exposed, non-exterior facing areas of the door, such as the sides of the first membrane and surfaces of the channel.

FIG. 11 shows an example side cross-section view of a panel door having an opening extending through a first membrane and a channel extending to a surface of a second membrane and entirely through a core positioned between the first and second membranes. The width of the opening and channel is constant along its entire length from the first membrane to the second membrane. A patch is positioned over the opening in the back face to cover the opening and form a continuous planar surface with the first membrane. A plurality of channels in a panel door can be similarly covered with patches to form a back face of the door that is a continuous surface. The patch or patches prevent environmental exposure to the exposed, non-exterior facing areas of the door, such as the sides of the first membrane and surfaces of the channel.

FIG. 12 shows an example side cross-section view of a panel door having a gap between a first core section and a second core section, the gap being covered and enclosed on both ends (i.e. facing the back face and the front face of the door) by the first membrane and the second membrane. The width of the gap is constant along its entire depth through the core area from the first membrane to the second membrane.

FIG. 13 shows an example side cross-section view of a panel door having a gap between a first core section and a second core section, the gap being covered on both ends by the first membrane and the second membrane. The width of the gap varies along its entire depth through the core area from the first membrane to the second membrane. The gap shape is defined by curved surfaces extending between the first and second membranes.

FIG. 14 shows an example side cross-section view of a panel door having an opening extending through a first membrane and a channel extending to a surface of a second membrane and entirely through a core positioned between the first and second membranes. An insert is positioned in the channel to cover the opening and form a continuous planar surface with the first membrane.

FIG. 15 shows an example side cross-section view of a panel door having a plurality of cutout portions extending through the core along the entire width of the panel door, and the plurality of cutout portions being arranged in the central area between the membranes from the top surface to the bottom surface of the door. Each of the cutout portions of the plurality is positioned in the core and does not contact either the first membrane or the second membrane.

FIG. 16 shows an example front face cross-section view of a panel door having a plurality of cutout portions extending through the core from a surface of the first membrane (not shown) to a surface of the second membrane. Each of the cutout portions of the plurality is positioned in the core and are in contact with or exposed directly to the first membrane and/or the second membrane. The plurality of cutout portions is positioned in the core and do not contact the perimeter edges of the door or core material positioned between the first and second membranes.

### DETAILED DESCRIPTION

The terminology as set forth herein is for description of the embodiments only and should not be construed as limiting the invention as a whole.

Herein, when a range such as 5-25 (or 5 to 25) is given, this means preferably at least or more than 5 and, separately and independently, preferably not more or less than 25. In an example, such a range defines independently 5 or more, and separately and independently, 25 or less.

The present disclosure relates to a panel door, such as a single panel door, that avoids discreet hinged or jointed sections while maintaining flexibility to traverse along a track, that can include a curve, for operating the door between a variety of positions, for example, opening and closing a door for access to the interior of a storage unit, garage, warehouse, building, freezer, truck or trailer. The doors of the present disclosure are sufficiently flexible to open and close while providing reduced weight or the need of springs or counterweights. Other advantages of the invention are apparent from the descriptions, in combination with the drawings, whereby by way of illustration and example embodiments of the invention are disclosed.

The panel door is designed to roll open and closed in tracks, for example, along a radius of curvature (e.g., 5-30 inches) in a portion of a track. The tracks that transition a roll door between two positions that vary by an angle in the range of 60-120 degrees (e.g., 90 degrees). The door can be any desired size or shape, for instance, door sizes can range from about 6 feet to about 10 feet in width, and about 6 feet to about 12 feet in height.

Likewise, the thickness of the door can be designed as desired and up to, for example, 2-12 inches in thickness.

The panel door includes a composite of a first membrane, a central area, and a second membrane. The central area includes one or more core materials and the central area is sandwiched between the first and second membranes. The first membrane forms a back face of the door and the second membrane forms a front face of the door. To accommodate operation of the door, suitable hardware and wheels can be attached to the door, for instance, for allowing the door to be aligned with and roll in track to guide the opening and closing of the door. The hardware such as metal brackets, sleeves or blocks can facilitate attachment of the wheels to the door. Hardware and/or wheels is positioned at or near a first side surface and a second side surface of the door, which connect the top and bottom surfaces of the door to define its perimeter. In an example, hardware and/or wheels is positioned on a portion of the back face of the door near or at the side surfaces of the perimeter such that the wheels extend past the side surfaces of the door to engage tracks used to guide the door during operation.

The first membrane covers and protects the central area including the core or a portion thereof from physical damage during use such as exposure to the environment or equipment operating around the door (e.g., a forklift, pallet jack). The first membrane includes a thermoplastic material. The thermoplastic material can be a single sheet that forms an outermost surface or back face of the door. The thermoplastic material includes a polymeric material. Polymeric material can include, but is not limited to, polypropylene, polyethylene, poly vinyl chloride, polycarbonate, polyacrylic, polymethylmethacrylate, polystyrene, and combinations thereof. The thermoplastic material of the first membrane can be reinforced to strengthen the material. Reinforcement materials can include fibers, for example, continuous, discontinuous, or chopped fibers. Fibers can include any suitable fiber or combination of fibers, for instance, glass, polyamide, polyester, cellulose, carbon, aramid and the like. The first membrane, and the second membrane described below, can be single layer or two or more layers laminated together (e.g., a multilaminate layer) as desired.

The second membrane similarly covers and protects the central area including the core or a portion thereof to form a front face of the door. The second membrane includes a thermoplastic material, and optionally a reinforcement material, as described for the first membrane. In an example, the first and second membranes can have the same compositions. The second membrane preferably forms a continuous linear surface such that the front face of the door is devoid of hinge seams.

The core material positioned in the central area between the membranes provides integral strength and optionally rigidity to the door and, in instances, insulating properties, without resulting in significant weight increase. The core material is sandwiched between the first membrane and the second membrane. In some embodiments, the core is adhered directly to the first membrane, the second membrane, or both. Any suitable adhesive or bonding agent can be used to adhere the core to the membranes. In another example, the cores and membranes can be formed together by thermoforming the panel door. The core material can be any suitable material, for example, a honeycomb or a foam. Examples of a foam can include, for instance, closed cell foams (ethylene vinyl acetate foam), polyethylene foams, polypropylene foams, and neoprene foams, and open cell foams such as polyurethane or polyether-or polyester-based polyurethane foams.

The flexibility of the first and second membranes, in combination with the core material, allows the panel door to flex along its length without having to be separately hinged together in sections to traverse a curved track. The flexibility of the door can be increased by forming one or more openings in the back face that each continuous with a channel in the central area, where the openings and channels preferably span the entire width or length of the door from a first side to a second side of the door perimeter, which sides connect the top and bottom sides of the door. The openings in the back face and related channels in the central area can be spaced along the height of the door, for example, equally spaced apart from one another at predetermined intervals along the door height spanning from the top surface to the bottom surface of the door. Openings in the back face and channels in the central area or core can be formed by one or more or a combination of conventional methods, for example, molding, cutting, milling, etc.

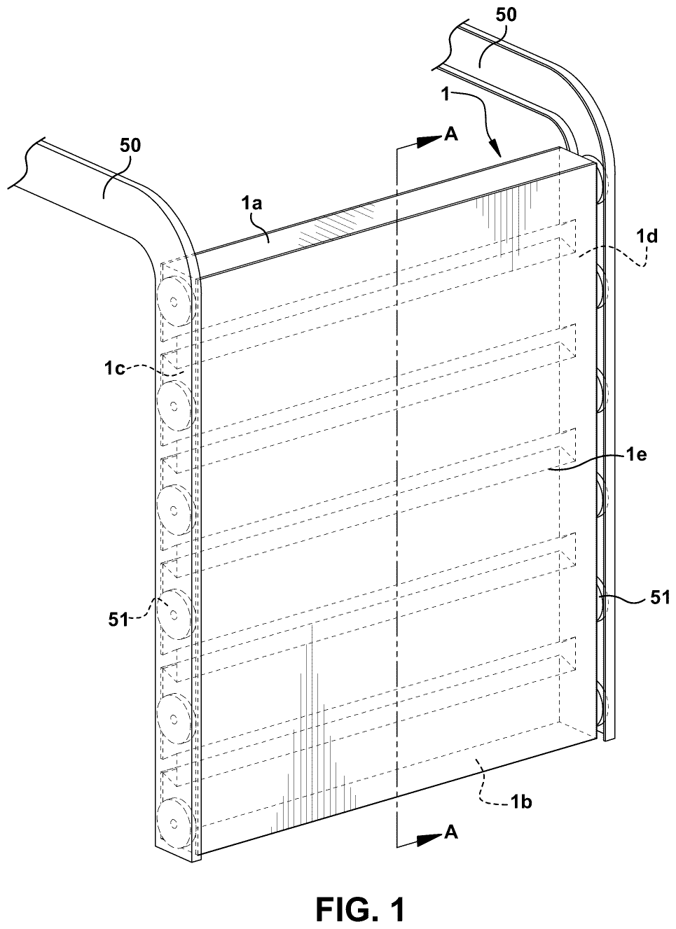

Turning to the figures, FIG. 1 shows an illustration of a single panel door 1 arranged in a closed position in a pair of tracks 50 with each track 50 having a curved portion to guide door 1 through a 90-degree bend to be arranged in an open position. To assist the door in traversing along a length of the tracks, wheels 51 are secured at or near side surfaces of the door. The wheels 51 reside in an interior portion of the tracks and roll to traverse door 1 in the tracks. Door 1 has a front face 1e facing outward and a back face opposite the front face 1e that faces rearward, for example, towards the inside of a container, trailer or interior of a storage vessel. Door 1 has a perimeter made of a top surface 1a, a bottom surface 1b, a first side surface 1c and a second side surface 1d.

To provide panel door 1 flexibility to traverse a curvature in the tracks 50, door 1 has a plurality of spaced apart openings on the back face that further opening into channels in the central area of the door between the front face 1e and the back face. The openings in the back face and the connected channels to the openings in the central area extend from the first side surface 1c to the second side surface 1d of door 1. The topmost opening and channel and the bottommost opening and channel of the plurality are spaced away from the top surface 1 and bottom surface 1b of door 1 so as to not intersect with the top and bottom surfaces of the door perimeter.

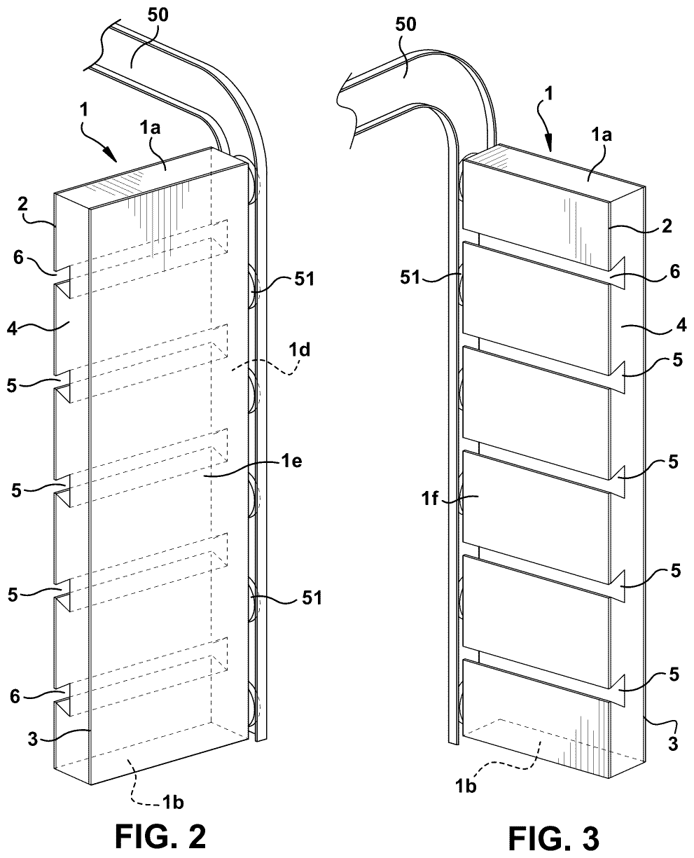

FIG. 2 shows a portion of door 1 taken along section line A of FIG. 1. FIG. 3 shows the other portion of door 1 (not shown in FIG. 2) taken along section line A of FIG. 1.

FIG. 2 shows a continuous core material in the central area 4 between front face 1e and back face 1f. As exposed by section line A of FIG. 1, it is shown a plurality of openings 6 in back face 1f that is formed by first membrane 2. Each opening 6 is connected with a channel 5 in core material 4 thereby forming an open area along the length of the back face 1f of door 1 that exposes sides of the first membrane 2 and surfaces of core material 4. As shown, the side walls of each channel 5 are not parallel with one another and are each angled away from each other at a constant and progressing alignment. The width of each channel 5 formed by the side walls of the channel is equal to the width of the opening 6 it is in communication with and as the depth of the channel progresses inward into core material 4 and towards front face 1e, the channel width increases along the entire depth of channel 4. The design of opening 6 and channel 5 combination provides a reduced opening width while the increased width of channel 5 allows for improved flexibility of door 1 at each opening and channel combination. The reduced opening widths provide a more uniform and continuous appearance on back face 1f of door 1 while also minimizing the exposure to internal portions of core material 4.

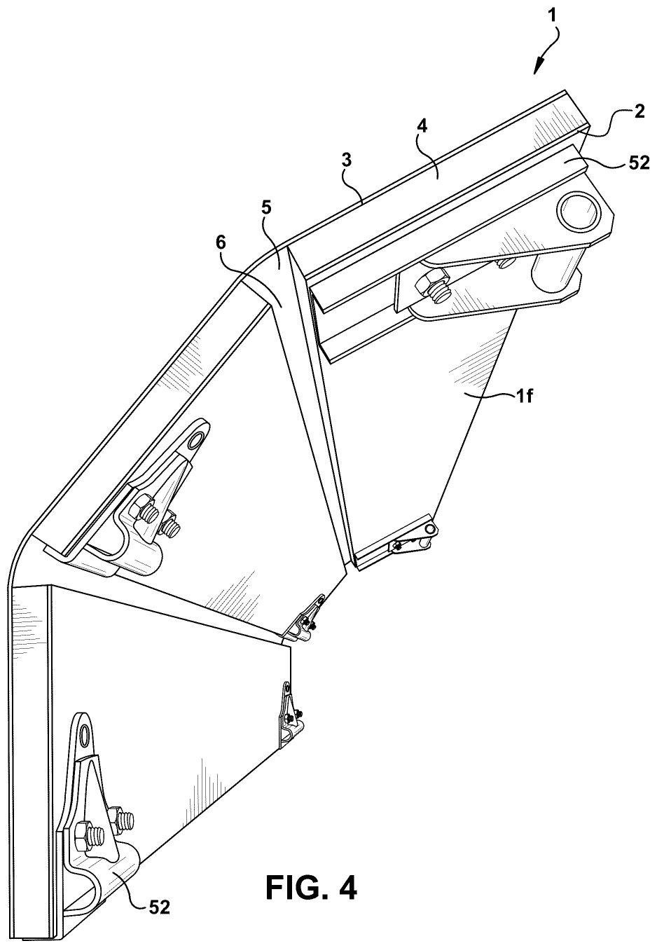

Door 1 of FIG. 3 illustrates channels 5 and openings 6 extending across the back face 1f and core material 4 through the side surface of the perimeter of the door. The plurality of openings 6 in back face 1f form a discontinuous face as compared to front face 1e that is continuous as formed by second membrane 3. Wheels 51 are arranged on the side surface of the perimeter door 1 for aiding in traversing door 1 along track 50. In another embodiment, FIG. 4 shows hardware or brackets 52 secured to back face 1f of door 1. Each hardware piece or bracket is arranged on a section of back face 1f of door 1, at or near the side surface of the door perimeter, that alternates between openings 5 and corresponding channels 5 that run along the entire back face 1f from a first side surface to a second side surface of the perimeter of door 1. The hardware or brackets can be joined with a roller wheel and shaft (not shown) to form wheels that extend outward from a side surface of the door perimeter and engage with a track for guiding door 1 between an open and closed position. For example, a wheel can be arranged on a shaft that can extend into openings of each bracket 52 for securing the wheel in position at the perimeter edge of door 1 for engaging a track.

Turning to the other figures, various configurations of openings in the back face of the door and corresponding channels in the central area are shown as example embodiments of the present invention.

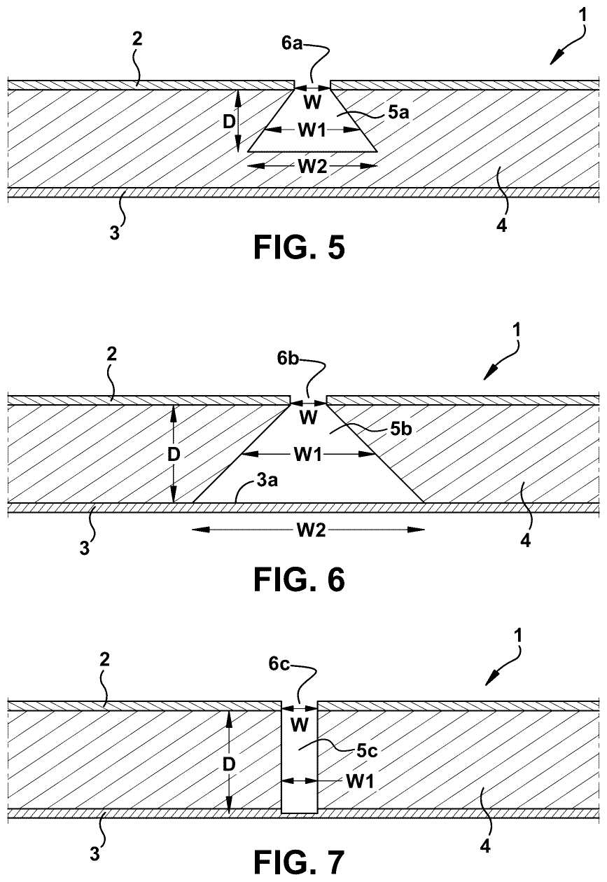

As an example of a channel in the central area in register with an opening in the back face through a first membrane, FIG. 5 shows a side cross-section view of a panel door 1 with a thickness measured from first membrane 2 (back face) to second membrane 3 (front face). Door 1 has a triangular shaped channel 5a formed in core material 4 in the central area. Channel 5a opens to opening 6a in first membrane 2 of the back face of door 1. Channel 5a does not contact second membrane 3 but forms an exposed material surface region in the central area of door 1 that includes portion of first membrane 2 and core material 4. The bottom surface of the channel to the second membrane 3 contains core material 4 in a reduced thickness as compared to core material 4 thickness on either side of channel 5a.

Opening 6a has a smaller width (W) as compared to the average width of channel 5a along its depth (D) such that the width of channel 5a constantly increases below first membrane 2 along its entire depth (D). The first and second channel side surfaces are angled outward from opening 6a in a continuous configuration. Minimizing width (W) of opening 6a in first membrane 2 reduces debris and environmental impact on the exposed surfaces of core material 4 in channel 5a while the increased width of channel 5a below first membrane 2 imparts desirable flexibility to the door at the channel 5a and opening 6a area. Although not shown, channel 5a can have a layer or coating that covers exposed portions of first membrane 2, core 4, or a combination thereof. Channel 5a can also include other shapes as desired, for example, a circular opening positioned in the central area or core material 4 below first membrane 2.

As shown in FIG. 5 and in FIG. 6, channel 5a, 5b has a bottom channel surface facing second membrane 3 that has width (W2), the greatest width portion of channel 5a, 5b. Width (W2) of channel 5a, 5b can be 1.2, 1.5, 2, 2.5, 3, 3.5, 4, 4.5 or 5 or more times greater as compared to width (W) of opening 6a, 6b formed in first membrane 2 of the back face of door 1.

FIG. 6 shows another example, in a side cross-section view, of a channel 5b in a portion of core material 4 of a panel door 1. Channel 5b has a triangular shape that is aligned with opening 6b in first membrane 2, and channel 5b and extends from below opening 6b in membrane 2 and entirely through core material 4 to a first surface 3a of second membrane 3, first surface 3a being opposite of the exterior surface of the front face of door 1. Surface 3a of second membrane 3 is exposed to the environment through opening 6b, as well as portions of core 4 and first membrane 2. The exposed portions of channel 5b or opening 6b can optionally be coated with a suitable material to prevent damage, degradation and the like to the core and membrane surfaces. Similar to channel 5a in FIG. 5, the first and second channel side surfaces angle outward from opening 6b through core material 4 in a continuous configuration such that channel width (W1) continually increases along the entire depth (D) of channel 5b. As such, the first and second channel side surfaces are not parallel with one another and are angled away from one another along the channel width.

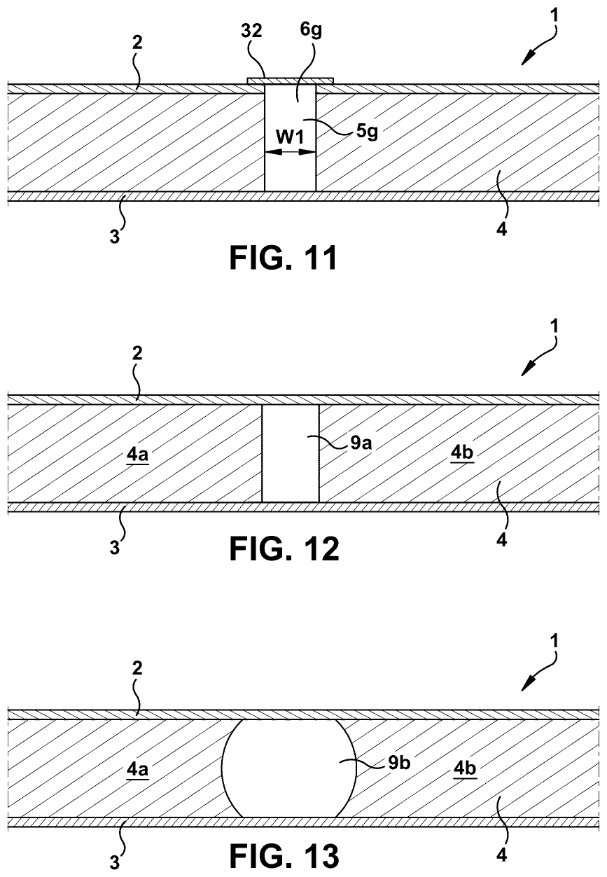

FIG. 7 illustrates another example of a channel 5c that extends from below an opening 6c in first membrane 2, through core material 4 in the central area between the two membranes 2,4, and into an interior portion of second membrane 3 forming the front face of door 1. Channel 5c has a constant width (W1) along its depth (D) spanning from first membrane 2 into part of second membrane 3. As shown, channel 5c terminates in the interior portion or region of second membrane 3 thereby exposing an interior section of membrane 3 along with portions of core material 4 and side surfaces of first membrane 2 because channel 5c is aligned with opening 6c such that the width (W) of opening 6c is the same as the width (W1) of channel 5c. FIG. 11 similarly shows channel 5g, of constant width (W1) along its depth to second membrane 3. All exposed surfaces formed by channels 5c, 5g can be coated to protect from damage during operation of door 1. In addition to or alternative to a protective coating (not shown), a flexible seal, insert or cover 32 can be applied to first membrane 2 of the back face to cover the entire opening 6g in first membrane 2 and interior of channel 5g. Flexible cover 32 can be adhered to first membrane 2 to ensure it remains in place during operation of the door. Flexible cover 32 can be any suitable material, for instance, a polymeric material or an adhesive tape or film, which can be applied to other embodiments described. Preferably cover 32 is a thin material that accommodates forming a smooth and continuous back face surface of door 1.

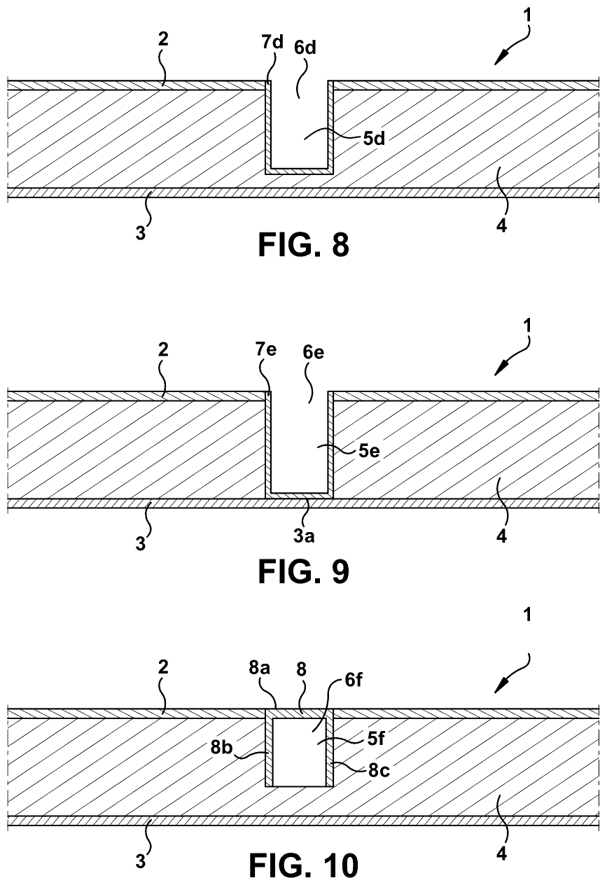

FIGS. 8 and 9 shows channels 5d, 5e in a side cross-section view of a single panel door 1. Top section of channel 5d extends aligns with opening 6d extending through first membrane 2 to expose a portion of core material 4, the channel terminating in the interior region of core material 4 and thereby forming an area of reduced thickness in core material 4 at the channel location. Channel 5d and opening 6d are lined with layer 7d that that covers exposed surfaces of core material 4 and side surfaces of first membrane 2 formed during formation of the channel 5d in door 1. Layer 7d provides protection from damage to the exposed interior portions of door 1 and can be formed of any suitable material, for example, a flexible material that accommodates the door flexing around a radiused corner during operation. For instance, layer 7d can be formed of a rubber composition or thin polymeric material such as PVC or a polypropylene film. Layer 7d can have a smooth surface for ease of cleaning and to provide an aesthetic appearance to the opening 6d and channel 5d cutout portion as compared to exposure of multiple materials such as foam that can easily collect dust and debris that imparts an undesirable appearance to an outermost surface of the door. An adhesive or other means (e.g., sonic welding) can be used to secure layer 7d to the exposed surfaces of core material 4 and first membrane 2 that define surfaces of channel 5d and opening 6d as shown, or such a combination that includes a channel in any other shape (e.g., triangular, circular, etc.).

Opening 6e extends through first membrane 2 to align with channel 5e that entirely extends through core material 4 to the first surface 3a of second membrane 3. Layer 7e covers exposed surfaces of first membrane 2, core material 4 and first surface 3a of second membrane 3 as similarly described above for layer 7d.

As shown in FIG. 10, the surfaces of channel 5f can be covered with an insert to form a planar surface with the adjacent surface of first membrane 2 of door 1. Opening 6f extends through first membrane 2 to open to channel 5f that extends into a portion of core material 4, terminating in the interior region of core material 4. Alternatively, not shown, channel 5f can extend entirely through core material 4 to either expose a surface or interior portion or region of second membrane 3. Insert 8 is fitted in opening 6f and channel 5f to close opening 6f formed in first membrane 2. Insert 8 has a flat top portion 8a and two side portions 8b, 8c. As shown, top portion 8a is aligned with first membrane 2 to form a planar surface free or substantially free of cavities or grooves that can undesirably collect debris during use of door 1. Side portions 8b, 8c of insert 8 reside along and/or press against exposed surfaces of core material 4 in channel 5f. Insert 8 can be slid into channel 5f during assembly of door 1 and, if desired, insert 8 can be attached or bonded to surfaces of portion 5f, for example, with an adhesive or attachment means. Insert 8 can optionally have a bottom portion that abuts the bottom exposed core material 4 surface or second membrane 3 surface.

FIGS. 12 and 13 show another embodiment of a side cross-section view of door 1 having gap 9a, 9b in core material 4 sandwiched in the central area between first membrane 2 and second membrane 3 that respectively form the back face and front face of door 1. Gaps 9a, 9b are enclosed by continuous membranes 2,3 such that core material 4 is not exposed to the environment or forms an outermost surface of the door. FIG. 12 shows a rectangular gap 9a in core material 4 such that core material 4 is split into first 4a and second 4b sections on respective sides of gap 9a. Gap 9a extends through the entire core material 4 to traverse the door from first membrane 2 to second membrane 3, and for example, gap 9a and other channels described herein can extend along the entire length of a core material 4 from a first side to a second side of the door to for a continuous channel or gap for forming a flex point for traversing the door around a curve, such as in a track or guide. Thus, when viewing core material 4 from the top to the bottom of the door, core material 4 is not continuous but rather can have one or more gaps arranged along its height, for instance, a plurality of gaps spaced apart from one another that create core material sections isolated between the gaps and first and second membranes. As noted, inclusion of one or more gaps provides multiple benefits in that each gap imparts improved flexibility to the door and reduces the weight of the core thereby also reducing material cost. FIG. 13 shows another example gap 9b having a partial circular shape with radiused edge faces, convex to one another, of a first 4a and second 4b section of core 4. In addition to the gap shapes represented herein, any suitable shape can be used, for instance, oval, diamond, triangle.

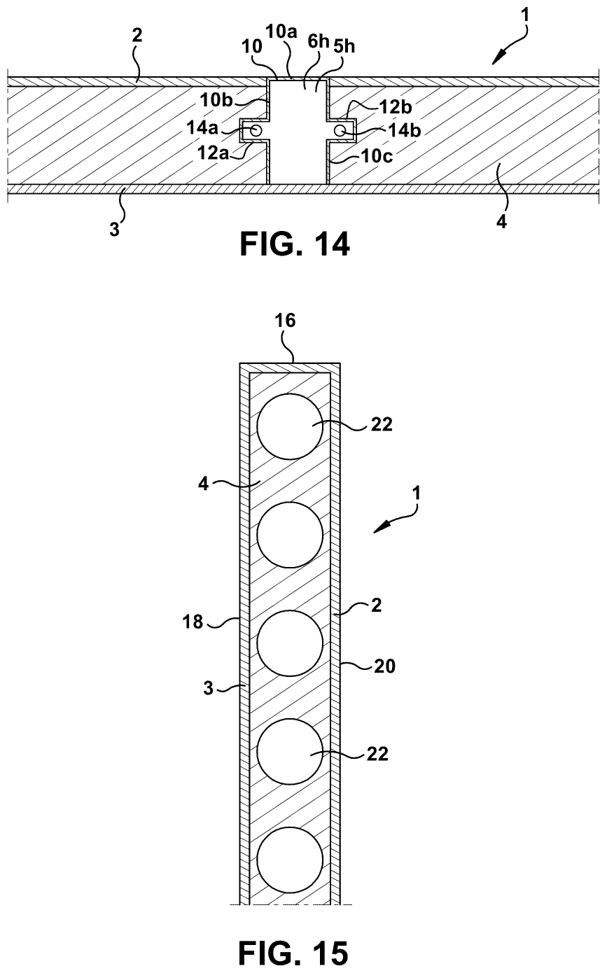

FIG. 14 illustrates another example of a channel 5h as viewed in a side cross-section of door 1. Opening 6h extends through first membrane 2, and aligns with channel 5h that goes entirely through core material 4 to a first surface of second membrane 3. Insert 10 is fitted in channel 5h to close opening 6h formed in first membrane 2. Insert 10 has a flat top portion 10a and two side portions 10b, 10c. As shown, top portion 10a is aligned with first membrane 2 to form a planar surface that can be free or substantially free of cavities or grooves that can collect debris during use of door 1. In the instance of door 1 having multiple openings and channel combinations, each opening or channel can be fitted with an insert to cover openings in first membrane 2 to form a continuous planar outermost surface on the front or back face of door 1, depending on which direction the channel portions are arranged.

Side portions 10b, 10c of insert 10 reside along and/or press against exposed surfaces of core material 4 in opening 6h and channel 5h. Channel 5h has two grooves 12a, 12b that extend into core material 4 and run continuously along the width or length of door 1 from a first side surface to a second side surface. Grooves 12a, 12b function to retain and secure insert 10 in channel 5h. Reinforcements 14a, 14b can be positioned in grooves 12a, 12b and inside of insert 10 that lines grooves 12a, 12b to add strength and secure insert 10 in place in channel 5h during operation of door 1. Insert 10 can be slid into channel 5h during assembly of door 1 and, if desired, insert 10 can be attached or bonded to surfaces of portion 5h, for example, with an adhesive or attachment means. Insert 10 can optionally have a bottom portion that abuts the bottom exposed core 4 surface or second membrane 3 surface. As arranged in channel 5h, insert 10 entirely fill opening 6h and is flush with adjacent surface of first membrane 2 to form a continuous planar surface on the back face of door 1.

FIG. 15 shows a side cross-section view of door 1 having top surface 16, front face 18 formed by second membrane 3, and back face 20 formed by first membrane 2. Arranged in core material 4 are a plurality of cavities 22 that extend the entire width or length of door 1 from a first side surface to a second side surface. Cavities form open air spaces within core material 4 to impart flexibility to door 1 as selection locations along the height of the door for aiding traversing around a curve or bend in a track. As shown, cavities 22 are spaced apart from one another along the height of door 1 and reside in an interior portion of core material 4 without intersecting or contacting adjacent door components such as membranes 2, 3 or material of top surface 16 or bottom surface (not shown). Any suitable number of cavities in any suitable shape (e.g., circular (shown), square, diamond, triangle, oval) can be included in core material 4 and are preferably equally spaced to balance weight in door 1. Cavities 22 are closed on each end, for example by membranes 2, 3, or portions thereof that form a side surface, at or near the first side surface and second side surface of door 1.

Although not shown, back face 20 can have one or more openings in the membrane and respective channels that extend through first membrane 2 and into at least a portion of core material 4, for example, as shown in FIGS. 5-11. The presence of cavities 22, and optionally openings or channels, increases the flexibility of the door while reducing the weight of the core, which results in less material need and related cost.

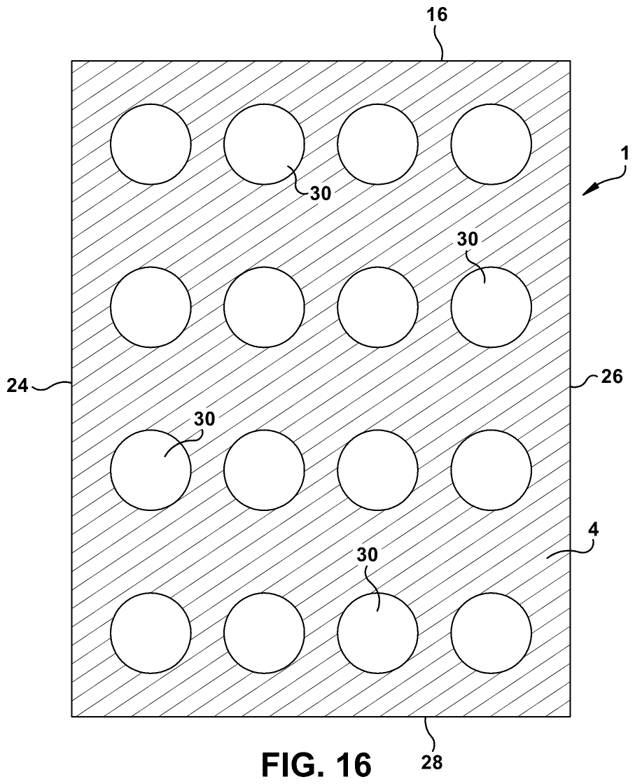

FIG. 16 shows a front face cross-section view of door 1 having top surface 16, first side surface 24, second side surface 26 and bottom surface 28, all of which define an interior of door 1 filled by core material 4. Within core material 4 is arranged a plurality of cavities 30 that extend the entire thickness of door 1 from a front face to a back face, formed by membranes as described above, that form outermost surfaces of door 1. Each cavity 30 is closed on its ends at or near the front face and back face of door 1, for instance, as formed by membranes 2, 3 or closed at its ends within core material 4. Cavities 30 do not intersect with side-defining surfaces 16, 24, 26, 28 of door 1 and any suitable number of cavities, in any suitable design or arrangement, in any suitable shape (e.g., circular (shown), square, diamond, triangle, oval) can be included in core 4 and are preferably equally spaced, such as in a matrix, to balance weight in door 1. As described above, the cavities 30, with or without additional openings and channels or combinations thereof, provide improved flexibility, weight reduction and cost savings to the door.

Other alterations or changes to the designs of the embodiment of FIGS. 1 through 16 can also be made. While the invention has been described in connection with various detailed embodiments and figures, the description is not intended to limit the scope of the invention to the particular forms set forth herein, but on the contrary, it is intended to cover such alternatives, modifications, and equivalents as may be included within the spirit and scope of the invention as defined by the appended claims.

1. A panel door for traversing a track, the panel door having a perimeter comprising a top surface, a bottom surface, a first side surface and a second side surface, the panel door comprising:
i. a back face formed by a first membrane;
ii. a front face formed by a second membrane;
iii. a central area positioned between the first membrane and the second membrane, the central area comprising a core material;
iv. an opening formed in the back face through the first membrane, the opening having a length extending from the first side surface to the second side surface, the opening having a width (W) perpendicular to the length of the opening;
v. a channel in the central area, the channel being open to the opening in the back face, the channel having a length extending from the first side surface to the second side surface, the channel having a width (W1) perpendicular to the length of the channel and a depth (D) extending from the opening in the back face inward towards the front face; wherein the width (W1) of the channel varies along its depth (D) and/or the depth (D) of the channel extends to the second membrane such that a portion of the second membrane is exposed by the channel.

2. The panel door of claim 1, wherein the width (W) of the opening formed in the back face is less than the average width (W1) of the channel positioned below the first membrane of the back face, the average width (W1) of the channel being taken along its depth (D).

3. The panel door of claim 2, wherein the ratio of the average width (W1) of the channel to the width (W) of the opening formed in the back face is in the range of 1.2:1 to 3:1.

4. The panel door of claim 1, wherein the channel extends entirely through the core material and to a first surface formed by the second membrane of the front face.

5. The panel door of claim 4, wherein the channel extends into the second membrane such that the second membrane has an area of reduced thickness.

6. The panel door of claim 1, wherein the channel comprises an inlet in communication with the opening in the back face, a first channel side surface, a second channel side surface, and a bottom channel surface.

7. The panel door of claim 6, wherein the first channel side surface is not parallel with the second channel side surface along the depth (D) of the channel.

8. The panel door of claim 6, wherein the first channel side surface is parallel with the second channel side surface along the depth (D) of the channel.

9. The panel door of claim 6, wherein the bottom channel surface has a width (W2) that is greater than the width (W) of the opening formed in the back face.

10. The panel door of claim 9, wherein the ratio of the width (W2) of the bottom channel surface to the width (W) of the opening formed in the back face is in the range of 1.2:1 to 3:1.

11. The panel door of claim 6, wherein a portion of the core material is positioned below the bottom channel surface.

12. The panel door of claim 6, wherein the first channel surface, the second channel surface or the bottom channel surface comprises an exposed surface made of the core material.

13. The panel door of claim 6, wherein the first channel surface, the second channel surface or the bottom channel surface comprises a cover layer overlying a portion of the core material of the central area.

14. The panel door of claim 1, wherein the channel comprises a non-rectangular shape.

15. The panel door of claim 1, wherein the channel comprises an exposed surface accessible through the opening in the back face, the exposed surface of the channel comprising a cover layer, the cover layer overlying a portion of the core material of the central area or a portion of the second membrane of the front face.

16. The panel door of claim 1, wherein the channel houses an insert, the insert comprises an outer surface and a portion of the outer surface of the insert forms a portion of the back face, the portion of the outer surface of the insert resides in the opening in the back face such that the opening is filled with the insert.

17. The panel door of claim 16, wherein the outer surface of the insert contacts a first channel side surface and a second channel side surface of the channel in the central area.

18. The panel door of claim 1, wherein the panel door comprises a plurality of channels in the central area, the plurality of channels being spaced apart from one another between the top surface and the bottom surface of the panel door.

19. The panel door of claim 1, wherein the central area consists of a continuous core material that contains the channel, the continuous core material directly contacting the first membrane and the second membrane.

20. The panel door of claim 1, wherein the central area comprises two sections of core material, the two sections of core material being spaced apart from one another to form a first channel side surface and a second channel side surface of the channel in the central area.

21. The panel door of claim 1, wherein the first membrane of the back face and the second membrane of the front face are formed of a fiber reinforced thermoplastic material, and the core material is a foam material adhered to the first membrane of the back face and the second membrane of the front face.

22. The panel door of claim 1, wherein the front face is a continuous planar surface.

23. The panel door of claim 22, wherein the panel door is a single panel door comprising a plurality of spaced apart channels in the central area, a plurality of openings formed in the back face through the first membrane, each opening of the plurality of openings having a length extending from the first side surface to the second side surface, each opening of the plurality of openings having a width (W) perpendicular to the length of the openings, each channel of the plurality of channels being open to an opening in the plurality of openings, each channel in the plurality of channels having a length extending from the first side surface to the second side surface, a width (W1) perpendicular to the length of the channel and a depth (D) extending from the opening in the back face inward towards the front face, wherein the width (W1) of each of the channels varies along its depth (D) and/or the depth (D) of each of the channels extends to the second membrane such that a portion of the second membrane is exposed by each of the channels, wherein the plurality of channels provides flexible sections to the single panel door for traversing a curved portion in the track.

24. The single panel door of claim 23, wherein the single panel door comprises intermediate sections between the plurality of channels, the intermediate sections being substantially rigid.
